(19) United States
(12) Patent Application Publication
(10) Pub. No.: US 2016/0331179 A1
(43) Pub. Date: Nov. 17, 2016

(54) TOUCHSCREEN CONTROLLER FOR FRYER

(71) Applicant: Technology Licensing Corporation, Fort Lauderdale, FL (US)

(72) Inventors: Bernard G. Koether, Fort Lauderdale, FL (US); Michael Keefe, Stratford, CT (US)

(21) Appl. No.: 14/713,650

(22) Filed: May 15, 2015

(51) Int. Cl. A47J 37/12; G06F 3/0488; G09B 19/00; G06F 3/0484

(52) U.S. Cl. CPC A47J 37/1266; G06F 3/04847; G06F 3/04842; G06F 3/04883; G09B 19/0092

(57) ABSTRACT

A controller for a fryer includes an engine for controlling operation of a fryer. A user interface application communicates with the engine, and stores at least one recipe having parameters for cooking a food product in the fryer. The user interface application controlling the engine to control the fryer within the parameters. A graphical user interface, in communication with the user interface application, has a touch screen control. The touch graphical user interface provides an image of the fryer. Touching of the image of the fryer sends a signal to the user interface application to begin the recipe.

### CROSS REFERENCE TO RELATED APPLICATION

This application claims the benefit of U.S. Provisional Patent Application No. 61/994,641, filed May 16, 2014.

### BACKGROUND OF THE INVENTION

The present invention is directed to a fryer controller, and in particular, a fryer controller having a programmable virtual graphical user interface (GUI) switch for controlling operation of the fryer.

Commercial kitchen appliances, particularly fryers, have become more sophisticated with the addition of additional electronics. The controls embedded in the appliance have become more varied, more numerous, and more complex. This has resulted in a variety of methods of operation between fryers as a function of the model and the manufacture of the fryer. However, this complexity while adding new subtleties in methodologies for preparing food has added a complexity to the food preparation process.

Given the time constraints of preparing food, the danger of getting too close to a fryer and the possibility of contacting spraying hot oils, and the physical location of the controls to conform to the frying structure, the cooks often press a button from memory without looking for the correct button for controlling the fryer. This happens even though there are several buttons on the fryer for adapting to this new complexity, increasing the likelihood of pushing the wrong button and improperly cooking the food.

As seen in FIG. 1, in an exemplary prior art fryer control panel, a plurality of switches 9 and 11-28 are provided in columns and rows. Each switch corresponds to a different manner of operation. Furthermore, the temperature control above and beyond any recipe is controlled from temperature button 7. Each of the switches 9 and 11-28 is identical to the touch; the only differentiator being the number printed thereon. Each switch is relatively flat and has a pressure transducer switch and an LED displayed within the switch. Therefore, to the touch they are substantially identical. As a result, the likelihood of pressing a wrong button to the untrained or new user of the control panel is substantial. As a result, the cooks utilizing the fryer desire a uniform interface to the fryer.

Furthermore, the prior art buttons are placed in a position below the fryer basket making them hard to see without bending over. Furthermore, bending over may require getting closer to the hot oil, putting the user at risk and requiring time to bend over for each loading of a basket of food to be fried. Accordingly, the cooks memorize the position of the button and press the button without bending over. However, not only does this increase the risk of pressing the wrong button, but because each food type has its own particular recipe controlled by that button because the button placements are memorized, the prior art solution to this problem requires that each fryer be dedicated to a particular food type, limiting the fryer use. While this enables the user to press the same button each time without having to look or feel for the button, it limits the ability to convert one fryer from chicken to fries, if there is such a change in demand.

Accordingly, a fryer control which overcomes the shortcomings of the prior art is desired.

### BRIEF SUMMARY OF THE INVENTION

A fryer includes a user interface application for operating a fryer in accordance with one or more recipes stored in the user interface application. A graphical user interface is disposed on the fryer and communicates with the user interface application. The graphical user interface has a sensor to determine whether the graphical user interface has been touched, the graphical user interface sending an output to the user interface application when touched to cause an engine, communicating with the user interface application, to perform a selected recipe at the fryer.

The graphical user interface may display an index of recipes when selecting a recipe. The GUI causes the controller to change the recipe with which it will operate the fryer.

In another embodiment of the invention, the graphical user interface has a single image; touching the image sends the signal to begin the frying process. The image may be a fryer including an image of a basket and cooking medium. The user interface application counts the number of times the basket is dropped into the cooking medium. The image of the fryer showing the oil as yellow when the counter indicates that the oil is clean, the color of the oil changing to brown when the counter determines that the oil is too dirty to comply for further cooking as a result of the number of operations performed.

### BRIEF DESCRIPTION OF THE DRAWINGS

The present disclosure is better understood by reading the written description with reference to the accompanying drawings and figures in which the reference numerals denote the similar structure and refer to the elements throughout in which:

FIG. 1 is a plan view of a prior art control panel for a fryer;

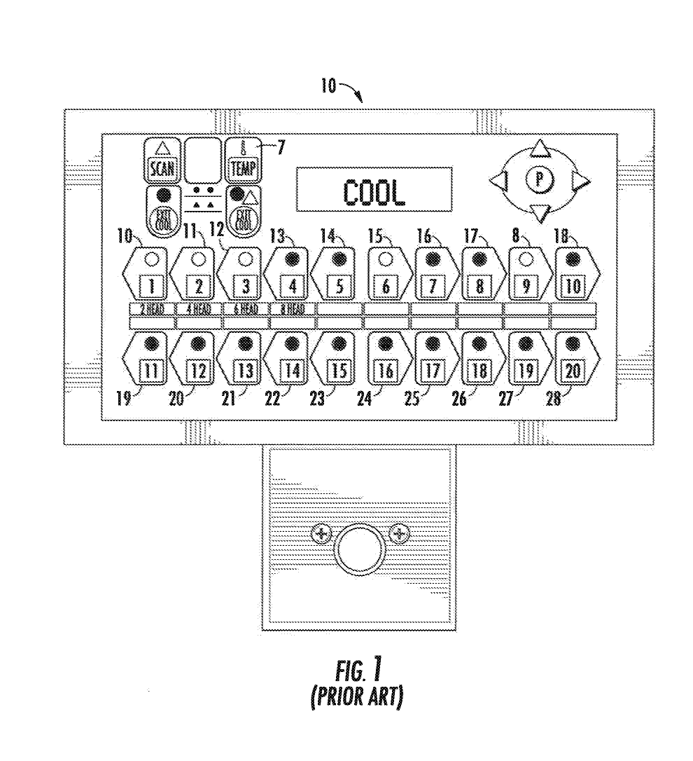

FIG. 2 is a schematic drawing of a system for controlling a fryer in accordance with the invention;

FIG. 3 is a schematic drawing of a system for controlling multiple fryers in accordance with the invention;

FIG. 4 is a graphical user interface for selecting to begin a frying process in accordance with the invention;

FIG. 5 is the graphical user interface during the operation of at least one fryer showing run time;

FIG. 6 is the graphical user interface showing the end of the frying process in accordance with the invention;

FIG. 7 is a graphical user interface in accordance with the invention for selecting recipes for the fryer; and

FIG. 8 is a flow chart for operation of the system in accordance with the invention.

### DETAILED DESCRIPTION OF THE PREFERRED EMBODIMENT

The present description is made with reference to the accompanying drawings, in which various embodiments are shown. However, many different embodiments may be used and thus the description should not be construed as limited to the embodiment set forth herein. Rather, these embodiments are provided so that this disclosure will be thorough and complete. Like numbers refer to like elements throughout.

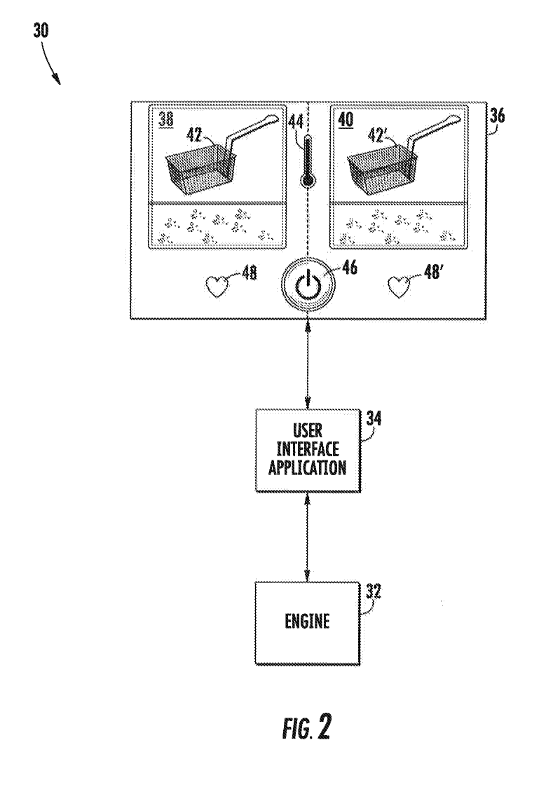

Reference is first made to FIG. 2 in which a schematic diagram showing the environment in which the invention is situated and performed is provided. A fryer control system 30 includes an engine 32. Engine 32 is the software and hardware for the basic operation of the fryer; i.e., turn fryer on, provides sufficient power to the heaters, cool the cooking medium, as well as operate the drain and the basket movement structure as is known in the art. Several manufacturers develop their own engines including Pitco, Henny Penny, Rationale, Ice Maker, Kitchen Brains, and the like. These manufacturers prefer to keep the operation of their engines proprietary and trade secret. The engine may be locally onboard the fryer; either in part or in whole, or may be stored in a cloud of servers; either in part or in whole.

Engine 32 communicates with a user interface application 34. User interface application 34 is software for controlling the operation of engine 32. As the user interface, it provides and receives the control signals as input at graphical user interface 36 as discussed in greater detail below. User interface 34 includes the recipes, (the time and temperature for cooking) to provide inputs to engine 34 to enable the fryer control (not shown) operated by engine 32.

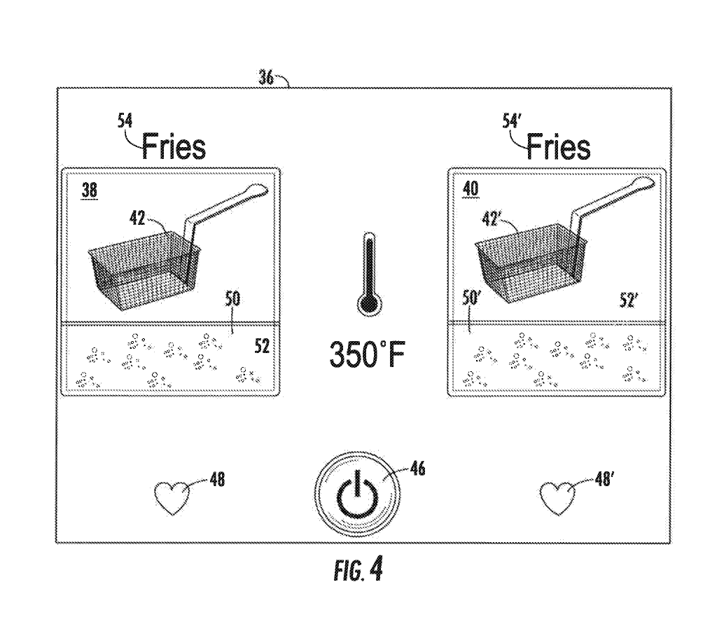

User interface application 34 also provides inputs to visual display 36 to enable the graphical user interface to intake instruction as a result of touching the appropriate portion of the graphical user interface (“GUI”) 36. By way of non-limiting example, as shown in FIG. 4 as will be discussed in greater detail below, graphical user interface 36 may be divided into two sections 38 and 40; each corresponding to a different fryer. Touching of the image of a basket 42, in GUI 36 (substantially anywhere within the vicinity of the basket), causes operation of a recipe assigned to that fryer by user interface application 34 to begin.

In response to being touched, GUI display 36 sends a signal to user interface application 34 to begin that recipe causing engine 32 to drop the actual basket corresponding to the fryer into the cooking medium and to operate in accordance with instructions from user interface application 34. In a preferred non-limiting embodiment, user interface application 34 may be incorporated into the visual display 36 as a single unit. Other graphics such as confirmation of cooking temperature, in the form of a thermometer 44, a start button 46 to initiate operation of the system as a whole, and image change buttons 48, 48′ may also be present in some embodiments of the GUI 36.

Reference is now further made to FIG. 4 in which the display of GUI 36 is provided for discussion of the system in operation. As can be seen, in a preferred embodiment, two images 38 and 40 are provided for providing inputs to control respective fryers. It should be noted, that two is a preferred embodiment, but a single image 38 or multiple images, of three or more baskets may be provided. However, having multiple images to some extent defeats the purpose of the invention. Utilizing image 38, by way of example, shows a graphical image of a basket 42 and frying medium such as shortening or oil 50. A type of recipe such as “fries” displayed as “FRIES” 54 above the graphical display shows the current recipe to the user. Touching GUI 36 (image 38) to the left will cause the actual basket associated with the recipe of image 38 to drop into the actual vat at the desired temperature, in this case for French fries at 350° F.

This is accomplished by GUI 36 outputting a signal when touched, to user interface application 34 to begin the recipe associated with image 38 which causes engine 32 to heat the cooking medium and lower the basket at the actual fryer. Similarly, touching GUI 36 in the vicinity of image 40 causes the second basket associated with a second recipe (can be the same recipe) to drop to cook fries in the second fryer. It should be noted, that because the fryers are different, fries may be cooked in the first fryer, while onion rings or the like may be cooked utilizing the second fryer.

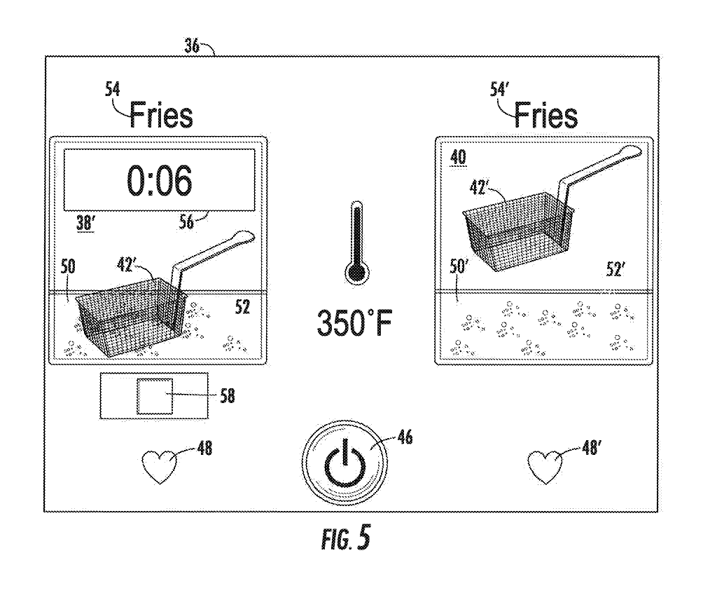

Reference is now made to FIG. 5, in which a GUI 36 is shown as operating during a cooking process. During cooking, GUI 36 will show an image 38′ of the basket 42′ having dropped into the cooking medium 50. A clock 56 appears showing the elapsed cook time for the fries. This is for the benefit of the chef as user interface application 34 causes engine 32 to lift the basket at the end of the predetermined time period in accordance with the recipe. It should be noted that in image 40, because the second batch of fries was not selected in our example, that that basket 42′ stays above the cooking medium. A virtual button 58 is provided which allows a user to stop the process by providing a stop signal, when touched, to user interface application 34 to stop engine 32.

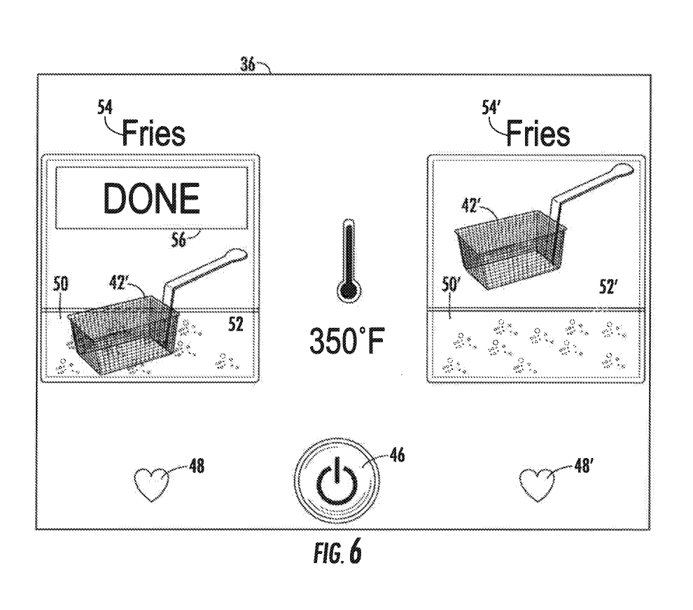

As seen in FIG. 6, display box 56 can indicate that the process is done in which engine 32 causes the true basket to be removed from the cooking medium or the basket is manually lifted, in the actual fryer and the virtual image will show the basket 42 above the cooking medium 50 to return to its original position.

It should be noted, that user interface application 34 counts the amount of time each basket 42 is within cooking medium 50 to calculate the cleanliness of the cooking medium and changes the graphic representation of cooking medium 50 to darken the shade of the cooking medium as well as to increase the density (number) of dirt pellets 52 illustrated in the cooking medium 50 to indicate that the cooking medium is becoming progressively dirtier. In this way, a user can track relative cleanliness of the cooking medium to help predict when the cooking medium needs to be replaced or filtered. As seen in FIG. 6, cooking medium 50 is darker than cooking medium 50′ and has larger and a greater density of pellets representing dirt particles 52 than 52′ in cooking medium picture 50′.

Because GUI 36 interface is easier to use than the conventional switches, the user need not memorize which button corresponds to which recipe. Therefore, the use of each fryer becomes more flexible and capable of more variety as the recipe is displayed clearly as element 54 and a user doesn't have to worry about hitting the wrong button.

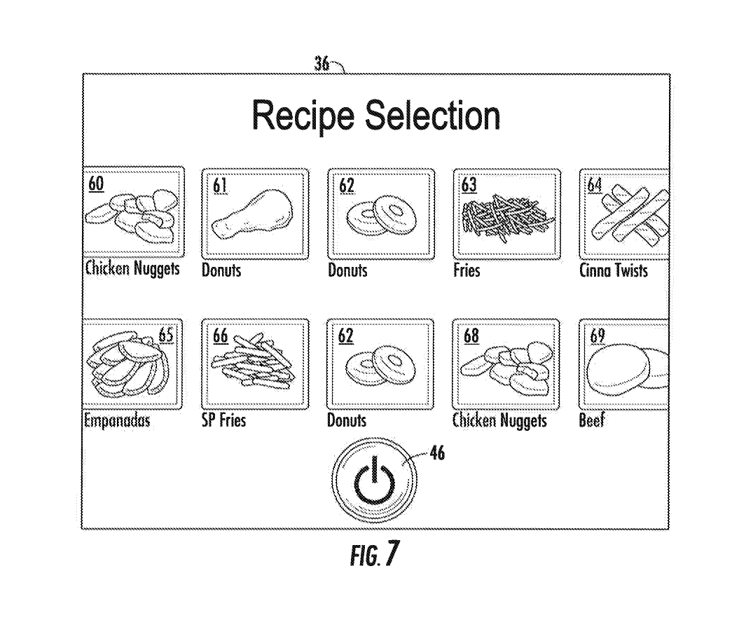

Accordingly, to make this available, virtual buttons 48, 48′ are provided which access to a menu of recipes stored in user interface application 34. As seen in FIG. 7, selection of either of buttons 48, 48′ causes images of different types of food 6069, by way of non-limiting example, to be displayed. Selection of another fried food such as chicken nuggets 60 or donuts 67 by touching the image on GUI 36 causes the recipe for the selected corresponding fryer to be changed at user interface application 34. Selection of button 46 causes the user interface application 34 to reset the recipe to the new corresponding image and to change the name 54 as well as the cook temperature and cook time associated with the fryer corresponding to virtual button 48 or 48′.

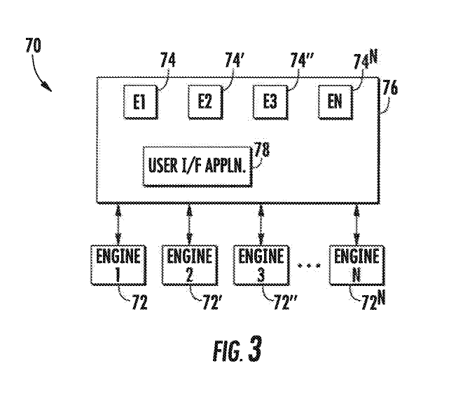

Reference now made to FIG. 3 in which a GUI input 76 for controlling operation of a fryer is provided in accordance with another embodiment of the invention. System 70 includes a GUI input 76 having a user interface application 78 incorporated therein for simultaneously controlling a number of engines 72-72ⁿ. In this embodiment, a single GUI interface 76 communicates with a number of engines 72-72ⁿ in two-way communication. Each engine has a corresponding graphical image 74-74ⁿ displayed on GUI 76. In an alternative embodiment, selection of a single one of images 74-74ⁿ may cause GUI 76 to display a single fryer image such as that shown in FIG. 2 with a medium and basket corresponding to the particular selected engine. In this way, a single user interface application 78 can control a number of engines and fryers.

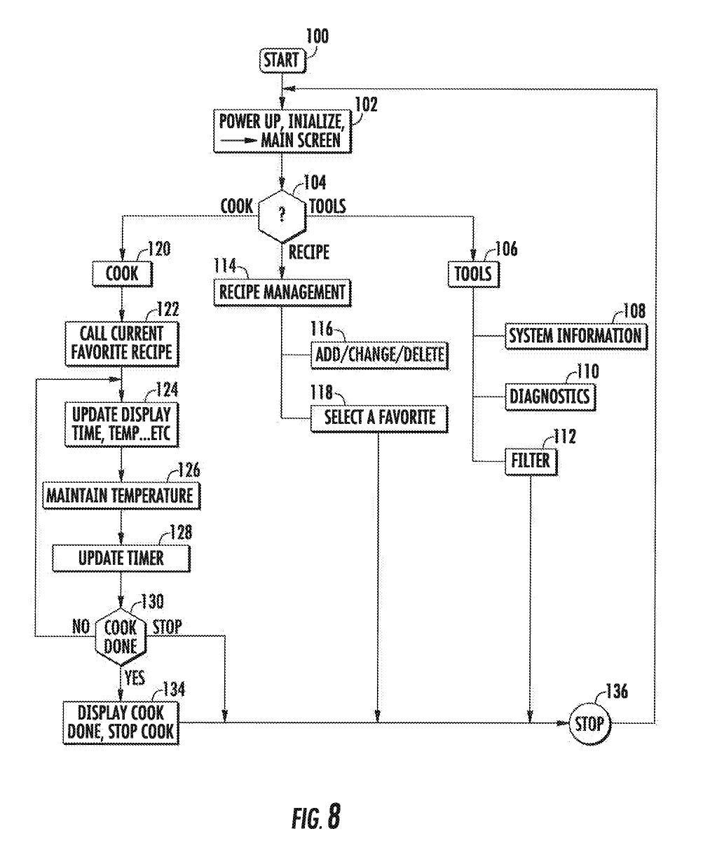

Reference is now made to FIG. 8 in which a flow chart of the operation of the user interface application 34 and engine 32 is provided.

The process is started in a step 100. The fryer is powered up, the engine 32 and user interface application 34 are initialized, and a first screen, much like that of FIG. 4, by way of non-limiting example, is displayed by GUI 76 in a step 102. Mode of operation whether to execute a cook operation, to change a recipe, or to perform a maintenance function is determined and selected in a step 104. If a maintenance function, utilizing internal tools, is selected in a step 106, then current system information is displayed at GUI 76 including diagnostics in a step 110. Diagnostics may include the current status of the cleanliness of the cooking medium, the number of cooks which have been performed since the last maintenance, a schedule for upcoming scheduled maintenance, or the like. If it is determined from diagnostic step 110 that the cooking medium needs to be filtered or changed in compliance with HACCP, other regulation, or good practice, in a step 112, the fryer will drain the cooking medium from the fryer through a filter if to be reused.

This filtering step, by way of example, may be performed automatically by user interface application 78 (FIG. 3) and engine 32, as a function of counting the number and overall time of performed operations by the fryer. It may also be performed in response to a manual input in response to viewing the relative appearance of cooking medium 50 within image 40 by way of example. Once the tools function is complete, functionality stops in a step 136 until the process is started again in step 104.

If recipe management is selected in step 104, then the recipe management functionality as stored in user interface application 78 is performed in step 114. A recipe may be added, deleted or modified, utilizing the GUI interface 76 in a step 116. The particular recipe to be performed most, is selected as a favorite for quick access in step 118 to initialize the system. The recipe functionality is then stopped in a step 134 and the process is returned to step 104.

If the cook operation is selected in a step 104, then a cook functionality is retrieved from user interface application 78. A current or preferred recipe is selected by user interface application 78 in response to an input as discussed above, from GUI 76 in step 122. Once the current recipe has been selected, the instructions for the recipe are sent from the user interface application 78 to engine 32 to control the fryer to perform in accordance with the recipe. In a step 124, the current temperature of the cooking medium and the updated elapsed time for the recipe being performed are displayed at GUI 76 in a step 124. In a step 126 engine 32 maintains the cooking temperature in accordance with the recipe, and in a step 128 the current elapsed time timer is displayed at 56 within image 38 in a step 128. In a step 130 it is determined whether or not the cooking is done. If not, the process is returned to step 124. If yes, then the GUI displays a “cook done” message in image 38 by way of example and cooking would stop.

The touch screen controller architecture discussed above, allows an application to communicate with specific internal electronics in the appliance to operate the appliance. In this way, each manufacturer may write their own application or contracts to handle the internal operation of the appliance, such as the temperature control algorithm. But the user interface application and communications are handled by the touch controller.

In one further embodiment, the user interface application and, to some extent, the engines may be stored in the cloud and user interface 34 may communicate with the cloud much in the way it communicates with the engine 32.

It should be noted, that engine 32, user interface 34 and GUI 36 are capable of communicating with each other wirelessly. However, in a preferred embodiment, each is connected to the other through conventional wiring, such as RS232, RS, RS485, various buses or the like.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and the modifications and embodiments are intended to be included within the invention.

What is claimed as new and desired to be protected by Letters Patent is:

1. A controller for a fryer comprising:
an engine for controlling operation of a fryer;
a user interface application, in communication with the engine for storing at least one recipe having parameters for cooking a food product in the fryer and controlling the engine to operate the fryer within the parameters;
a graphical user interface, in communication with the user interface application, having a touch screen control, and providing an image of at least a portion of the fryer, and touching of the image of the at least a portion of the fryer causes the graphical user interface to send a signal to the user interface application to perform the recipe.

2. The controller of claim 1, further comprising at least a second engine, the at least second engine controls the operation of at least a second fryer, and the at least second engine communicates with the user interface application, the user interface application controlling the at least second engine to operate the at least second fryer with in the parameters.

3. The controller of claim 1, wherein the user interface application stores at least a second recipe, having parameters for cooking at least a second food product in the fryer, and controlling the engine to control the fryer within the second parameters, the user interface application causing the graphical user interface to display a first image corresponding to the at least one recipe and a second image corresponding to the at least second recipe.

4. The controller of claim 3, wherein touching of the first image causes the fryer to perform a recipe in accordance with the at least one recipe, and touching the second image causes operation of the fryer in accordance with at least a second recipe.

5. The controller of claim 1, wherein the image of at least a portion of the fryer displays an elapsed time of the performing of the recipe at the fryer.

6. The controller of claim 1, wherein the image of the at least a portion of the fryer indicates a condition of the cooking medium associated with the fryer.

7. The controller of claim 1, wherein the graphical user interface presents a recipe, as an image, the graphical user interface causing the recipe to be at least one of added to the user interface application, changed, or deleted from the user interface application in response to touching of the image of the recipe.
